(19) United States
(12) Patent Application Publication
(10) Pub. No.: US 2010/0225670 A1
(43) Pub. Date: Sep. 9, 2010

(54) DISPLAY DEVICE AND METHOD OF PROVIDING ILLUMINATION THERETO

(75) Inventors: Hendrikus C W. Groot Hulze, Eindhoven (NL); Theo G. Zijlman, Tilburg (NL); Jeroen Den Breejen, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/303,735

(22) PCT Filed: Jun. 1, 2007
(86) PCT No.: PCT/IB2007/052070

§ 371 Date: Dec. 6, 2008

(30) Foreign Application Priority Data
Jun. 6, 2006 (EP) 06114982.9

(51) Int. Cl. G09G 5/10; G09G 3/32

(52) U.S. Cl. 345/690; 345/82

(57) ABSTRACT

The present invention proposes a method of providing illumination for a display device including a lighting unit having a plurality of light sources (104). Desired light outputs are determined (210) for each of the light sources (104) in accordance with image data to be displayed. The desired light outputs are compared (220) to a reference light output, and the difference is used to determine a power saving factor. The desired light output for one or more light sources is then increased (230) using the power saving factor. When the lighting unit is activated in accordance with these gained light outputs, a high contrast image is rendered on the display screen, which appears particularly visually appealing to a viewer. Optional steps (312)-(316) compensate for optical cross talk between adjacent backlight segments.

The invention relates to a method for providing illumination to a display device, such as a liquid crystal display (LCD) device having a backlight.

Certain types of passive display devices need to be provided with a lighting unit for displaying images. For example, a transmissive liquid crystal display device is generally provided with a backlight illuminating the liquid crystal display (LCD) panel from behind. Each picture element of the LCD panel constitutes an optical shutter, and can be individually controlled to modify the optical state of backlight passing through it. By placing the LCD panel between suitably arranged polarizers, effectively the amount of backlight passing through each pixel can be controlled and an image can be generated on the display panel.

Prior art display devices of this kind are provided with a backlight unit, where each light source provides a constant light intensity to the display panel during operation of the display. However, the LCD panel is not perfect, causing light leakage through the panel when the pixels are in the black (dark) state. The viewer thus perceives black parts of an image as dark grey, which is undesirable.

An improvement is proposed in U.S. Pat. No. 6,631,995, where the output of the lighting unit towards the display panel can be controlled in dependence of the image to be displayed on the panel. Thus, for dark images, the backlight provides reduced intensity illumination to the display panel. As a result, light leakage is less noticeable, and the viewer perceives a higher image quality.

It is an object of the invention to further improve the perceived image quality of a display device incorporating a lighting unit for providing illumination to the display.

This object is at least partly achieved by the invention as specified in the independent claim 1. Further advantageous embodiments are defined in the dependent claims.

According to a first aspect of the invention, a method for providing illumination to such a display device is proposed. The lighting unit has at least a first and second light source each corresponding to a portion of the display screen. Video image data to be displayed on the display device is received. This video image data is analyzed and a desired light output of each light source is derived so as to provide an optimal amount of backlight to the corresponding portion of the display screen displaying the video image data.

For example, if only a certain area of the display panel shows a relatively dark image, the amount of backlight to be provided to that area can be reduced accordingly, while the amount of backlight being provided to relatively bright image areas can be maintained or even increased if so desired.

The desired light outputs thus derived are compared to a reference light output of the backlight unit, and the difference is used to determine a power factor. Preferably, the reference light output corresponds to the nominal light output of the backlight unit, that is the light output of a backlight unit continuously illuminating the display panel at a nominal intensity, for example 100%. In this case, the power factor corresponds to a power reduction that is achieved by activating the light sources to these desired light outputs instead of activating them to the reference light output.

Subsequently, to ensure that the viewer perceives a particularly high quality image, the desired light output for one or more light sources is increased by at least part of this power factor. Preferably, the desired light output for each of the light sources is increased. Thus, the luminance of bright image portions, or preferably the total image, is boosted so that the image becomes particularly appealing to a viewer. It has been found that this final increasing of the light output has an unexpectedly large positive contribution to the perceived image quality.

An additional advantage is that in a display device using a method according to the invention, the amount of power consumed by the lighting unit may be reduced compared to a prior art lighting unit providing constant intensity illumination of the entire display panel (that is, operating each light source continuously at a light output level of 100%).

Preferably, the light sources are fluorescent lamps each corresponding to a segment of the display. The brightness of each fluorescent lamp can be controlled individually, so that each segment of the display can receive an amount of backlight that is optimized for the video image data being displayed on that segment.

Thus, in a preferred embodiment of a method according to the invention, firstly the video image data is received. Preferably the video image data is analyzed on a segment-by-segment basis. Then, the optimal light output for each fluorescent lamp, depending on for example the average brightness of the corresponding segment of the image, is determined. The light outputs are summed and compared to a total reference light output of all lamps taken together.

The reference light output is, for example, a nominal light output used for a conventional backlight, providing continuous illumination of the display at 100% lamp intensity. In this example, the comparison results in a gain factor corresponding to a power reduction factor. This gain factor is then used to boost the light output of all fluorescent lamps simultaneously. In one embodiment, the light output of each lamp is linearly boosted by an equal amount. In another embodiment, the light output of a lamp corresponding to a relatively bright image segment is boosted more than the light output of a lamp corresponding to a relatively dark image segment. This is either achieved through linear boosting the light outputs with respect to an offset level, or by non-linear boosting of the light outputs.

The resulting image has a relatively high contrast, particularly so in the latter embodiment, with relatively high brightness in bright parts of the image and relatively low light output (reduced light leakage) in dark parts of the image. Furthermore, the backlight is used in a more efficient way, so that power can be saved in addition to the increased quality of the displayed image.

In another preferred embodiment, the light sources are light emitting diodes (LEDs) or groups of LEDs, each LED or group of LEDs corresponding to an area of the display panel. The brightness of each LED or group of LEDs can be controlled individually, so that each area of the display can receive an amount of backlight that is optimized for the video image data being displayed on that area.

Similarly, preferably each image area in the video image data is analyzed and the optimal light output for each LED or group of LEDs, depending on for example the average brightness of the corresponding area of the image, is determined. Then, the power factor is determined and the light output of some or all LEDs is increased by at least a part of this power factor.

A method according to the invention will be most effective when applied in a display device having a relatively large number of light sources, so that the areas or segments corresponding to each light source are relatively small. Ideally, the display area has good segmentation, so that there is not much overlap between adjacent areas or segments. However, in practice some overlap will occur, and therefore, a preferred embodiment of a method according to the invention provides so-called cross talk compensation. That is, the contribution (cross talk') of the light output of an given segment or area to the light output of neighboring areas or segment is taken into account in determining the desired light outputs and/or the power factor. For example, if a relatively dark image area or segment is surrounded by relatively bright segments or areas, the light output of the light source corresponding to that relatively dark segment can be reduced even further.

The method according to the invention is preferably applied in a display device with a scanning backlight system, where each light source only illuminates its corresponding display area or segment during a fraction of the image refresh time. This fraction is referred to as the ‘duty cycle’ and is, for example, 30% or 40% of the image refresh time. Scanning backlight systems use bright lamps such as HCFL lamps having relatively high light output, and can easily provide the additional illumination that may be required in the final increasing step of the method by increasing the duty cycle for one or more light sources.

These and further aspects of the invention will be elucidated with reference to the accompanying Figs. Herein:

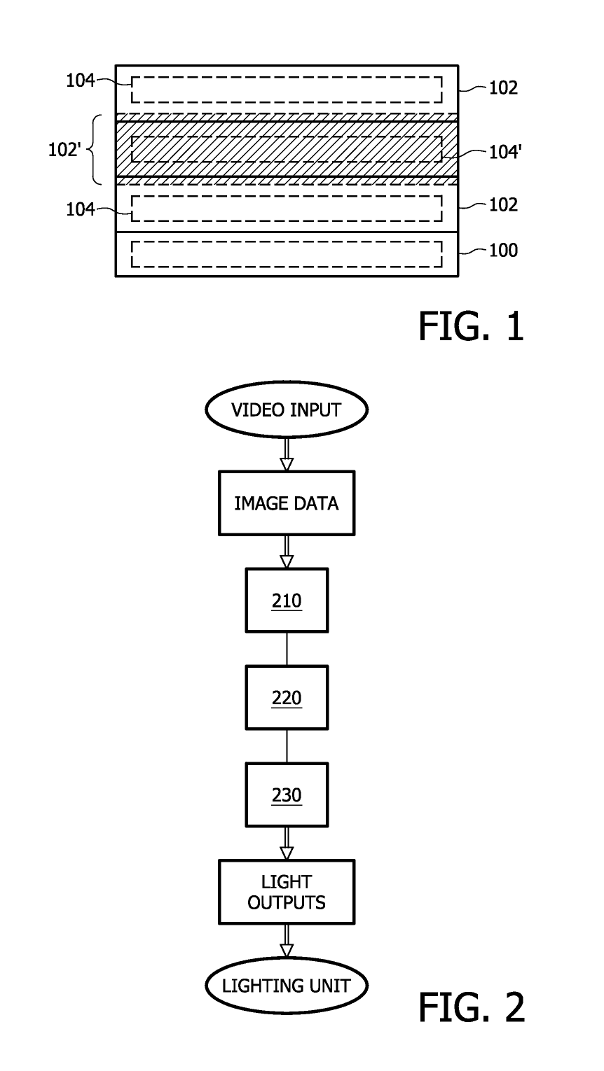

FIG. 1 is a schematic view of a display panel and lighting unit;

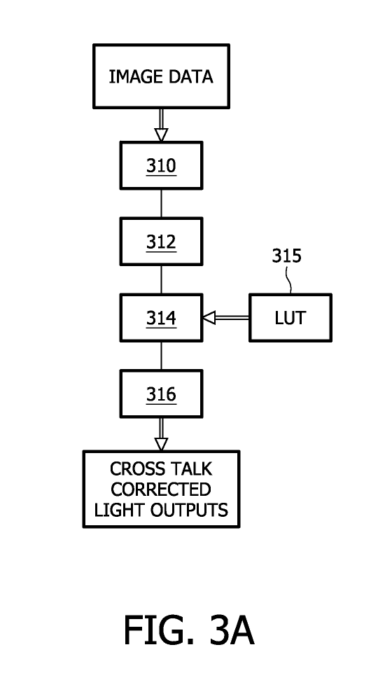

FIG. 2 is a block diagram showing a preferred embodiment of a method according to the invention, and

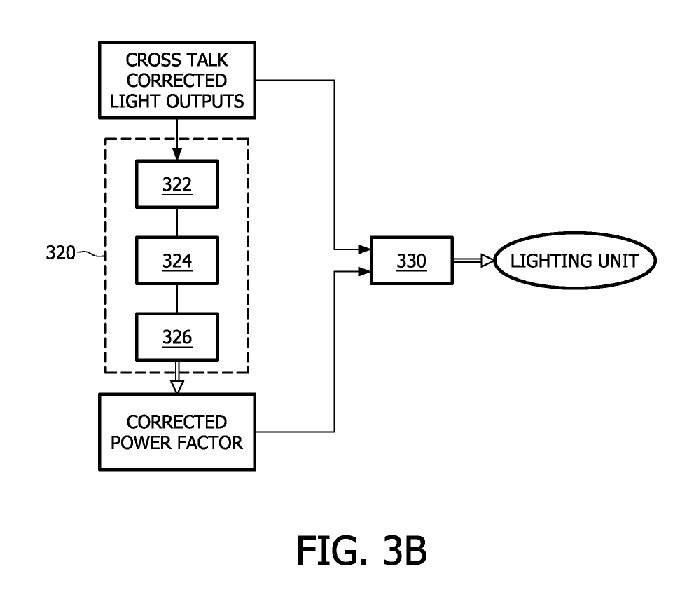

FIGS. 3A and 3B are block diagrams representing details of a further preferred embodiment of a method according to the invention.

In FIG. 1, an LCD display panel 100 is shown that is divided into four segments 102 extending along the width of the panel 100. Behind the display panel 100, a backlight unit is provided for illuminating the display panel from behind, towards a viewer. The backlight unit comprises a number of light sources, in this embodiment fluorescent tubes 104. Each fluorescent tube 104 corresponds to a segment 102 of the display panel.

The panel is provided with picture elements (pixels; not shown in the image) each constituting an optical shutter and being individually controllable to modify the optical state of backlight passing through it. Thus, an image can be formed on the display panel 100. An actual display panel as used in an LCD television has for example 1360 pixels in the horizontal direction (width) by 768 pixels in the vertical direction (height), or 1920 by 1080 pixels. Generally, the number of fluorescent lamps 104, and thus panel segments 102, is larger than four as shown in the image; for example, an actual backlight unit will have eight or twelve fluorescent lamps, and thus the display panel 100 comprises eight or twelve corresponding segments respectively.

The fluorescent lamps are cold cathode fluorescent lamps (CCFL) or hot cathode fluorescent lamps (HCFL) lamps; in the latter case, the backlight unit is preferably arranged as a scanning backlight, in which each lamp is subsequently activated according to a certain duty cycle, for example 30 or 40% of the image refresh time. Such a backlighting scheme is beneficiary in a liquid crystal display system, where it can eliminate the effect that viewers perceive motion blur due to continuous illumination of the image (the ‘sample and hold effect’).

Generally, the segmentation of the display is not ideal, but a certain overlap between segments 102 exists. For example, in FIG. 1, the second lamp 104′ is activated, and it can be seen that the illuminated (hashed) area extends outside the edges of the corresponding second segment.

The present invention relates to a method for illuminating a display panel. A preferred embodiment of the method will be described hereinafter.

The preferred embodiment is illustrated in the block diagram of FIG. 2.

In the first step of block 210, the image data to be displayed on the panel 100 is analyzed and a desired light output for each of the lamps 104 is determined. The desired light output is determined using standard techniques, for example, for each lamp, a histogram analysis of the image data of the corresponding display segment is made, and the light output is chosen so as to match with the average or mean brightness of the segment image data. In the preferred embodiment having a scanning backlight unit, not the actual power levels are used, but rather the light level control signal, which are an indication for the duty cycle of the lamps. That is, the lamps are generally driven at the same power levels, and the light output is modified by increasing or decreasing the duty cycle. Generally, at very low duty cycles the HCFL lamp efficiency is lower, which effect must be compensated for.

In the second step of block 220, the desired light outputs are compared to a reference light output, and a power factor is determined preferably representing the ratio between the two. Preferably, the reference light output is taken to be 100%, corresponding to continuous illumination of the display panel at nominal lamp output or duty cycle. In that case, the desired light outputs will generally be lower than the reference light output, and the power factor represents a power saving factor.

In the final step of block 230, generally the light output of each lamp is boosted using the calculated power factor. Preferably, at least part of the power saved through the determination of the optimal lamp output in blocks 210 and 220 is re-used for creating a visually more appealing image on the display screen.

As an example, for a specific image in a display system with twelve segments, the first analysis step has revealed that for six image segments the desired lamp output is 80% of the nominal lamp output, and for the other six image segments the desired lamp output is 20%. This leads to a power factor of 2, and thus all lamps can be boosted by a factor of 2. As a result, six lamps will provide 160% of the nominal light output, and six lamps will provide 40% of the nominal light output. The total amount of power consumed by the system is the same as when all lamps had provided the nominal light output, but the brightness distribution is optimally adapted to the image data. Dark parts of the image will show reduced light leakage, while for bright parts of the image the image brightness is particularly high, and visually pleasing.

Preferably, the method is repeated for every frame of image data, that is each image of a video stream is analyzed and subsequently light outputs for the backlight lamps are calculated in accordance with the invention.

The method is preferably embodied in the timing controller (TCON) and/or backlight controller. The timing controller is an IC located at the rear side of the LCD panel, connected to the row drivers and column drivers addressing the pixels of the LCD panel. The timing controller already receives the image data, and is thus suitable for performing the image data analysis and calculating the power factor. The desired and boosted power levels are preferably supplied to the backlight controller, which is then arranged for generating control signals for each light source of the backlight in accordance with these power levels and controlling the lamps correspondingly.

A further preferred embodiment of the method is illustrated in FIGS. 3A and 3B.

In the further preferred embodiment, after the first step 310 of analyzing image data for each segments and determining the desired light output for each corresponding lamp, a number of corrections are performed on the desired light outputs to obtain a further optimized brightness distribution.

Firstly, in block 312, the negative differences between a segment and its neighboring segments is limited. Preferably, a desired light output for a segment is compared to a predetermined fraction of the desired light outputs for the neighboring segments, and if it is lower, the desired light output is clipped to said fraction of the highest neighboring level.

In the next block 314, the actual light distribution over the display panel is calculated, taking into account the corrected desired light outputs from block 312 and cross talk between segments. The effects of cross talk on the light distribution are obtained from a look-up table 315, which contains, for this particular panel, a map of the light levels for a line or pixel of the image as a function of its position. For example, for a certain line in the third segment, the look-up table may reveal that 70% of the illumination originates from lamp 3, 25% originates from lamp 2 and 5% originates from lamp 4.

In block 316, cross talk compensation is performed, preferably by comparing the actual light levels with the desired light levels from block 310. Any error between the two is preferably fed back to correct the light levels from block 312. The correction more preferably used a polarity dependent gain factor (asymmetric correction). That is, more correction is used for negative errors (lack of light; desired light level is lower than requested level) than for positive errors (too much light). Without this asymmetrical gain of the error, the areas of bright segments bordering with relatively dark segments will appear too dark.

In effect, this cross talk compensation boosts the levels of relatively bright segments that are surrounded by darker segments, and further dims the levels of relatively dark segments that are surrounded by lighter segments. When properly aligned, cross talk compensation, and in particular asymmetrical cross talk compensation, can further enhance the contrast of an image displayed on the image screen.

FIG. 3B shows a preferred embodiment of a more detailed implementation of block 320 corresponding to block 220 in the first preferred embodiment.

Firstly, in block 322, the power factors for all segments are summed and the total is divided by the nominal light output level of the backlight. Thus, a power factor is obtained. Then, in block 324, the power factor is clipped to a highest allowed power factor. The highest allowed power factor is preferably user controllable, and can be set to about 2 to 3. This maximum is provided to ensure that not too much light is provided by the backlight unit; a very dark image should not be allowed to be displayed at high brightness. Optionally, block 326 provides a temporal low pass filter of the power factor. That is, a correction to the power factor may be provided so that it cannot rise and/or fall too fast. Preferably, the light output can be reduced quite dramatically, but an increase of the light output of the backlight should be gradual so as not to cause disturbing flicker.

The corrected power factor output from block 326 is finally used in block 330 to gain the cross talk compensated light outputs from block 316. The gain may be linear, that is all lamps are boosted by the same amount, in accordance with the power factor. Preferably however, the lamp output is gained with respect to an offset, which expands the light profile so as to preserve the darkest levels and enlarge the global contrast of the picture.

Linear gain can be represented by the following function:

BLO=CLO*PF

where CLO is the cross talk compensated light output from block 316, PF is the corrected power factor from block 326, and BLO is the boosted light output, which the backlight controller uses to determined the drive level for the lamps.

A linear gain with offset can then be represented by:

BLO=((CLO−OF)*PF)+OF

where OF is the offset.

The following table illustrates the contrast enhancement that can be achieved by using an offset of 20% in the boosting step, assuming a power factor of 1.5:

| CLO | BLO (no offset) | BLO (offset) |
|---|---|---|
| 20% | 30% | 20% |
| 60% | 90% | 80% |
| 100% | 150% | 140% |

As can be seen, the ‘original’ contrast ratio between cross talk compensated light outputs of 100% and 20% of the nominal light outputs is 5:1. After a linear gain without offset, this contrast ratio remains the same. However, using an offset leads to an increase in contrast ratio to 7:1 between these two luminance levels.

An alternative option to enhance the contrast is to use a non-linear gain in block 230.

Preferably, the invention is implemented in a scanning backlight system, where the lamps are operated in sequence at for example 30% duty cycle. This then corresponds to a nominal light output of 100%. In such a system, the light output of a lamp can easily be increased beyond 100% by increasing the duty cycle. Lamp levels can be boosted to 200% or even 250% without much effort, using a duty cycle of up to 80%. Even higher duty cycles are possible but not desirable due to increased perception of motion blur.

In the above, the invention has been described with reference to a LCD panel having a backlight unit including fluorescent lamps as light sources. However, backlights using an array of LEDs are equally suitable for implementing the invention. In this case, where reference is made in the above to a display panel segment corresponding to a lamp, ideally one substitutes a relatively small area of the display panel corresponding to a single LED. Alternatively, larger areas corresponding to groups of LEDs can be used.

1. A method for providing illumination for a display device including a lighting unit having at least first and second light sources each corresponding to a portion of a display screen, the method comprising:
receiving video image data;
determining a desired light output for each of the first and second light sources, in accordance with the video image data for the corresponding portion of the display screen;
determining a power factor by comparing said desired light outputs to a predetermined reference light output, and
increasing at least one of said desired light outputs by at least a fraction of said power factor.

2. The method of claim 1, wherein each of said desired light outputs is increased by at least a fraction of said power factor.

3. The method of claim 2, wherein each of said desired light outputs is linearly gained using said power factor.

4. The method of claim 2, wherein each of said desired light outputs is linearly gained using said power factor and an offset.

5. The method of claim 1, further including:
generating an actual light distribution resulting from the desired light outputs,
determining errors between the actual light distribution and a requested light distribution, and
gaining the desired light outputs in accordance with said errors.

6. The method of claim 5, wherein said gaining is effected using a polarity dependent factor.

7. The method of claim 5, wherein the step of generating the actual light distribution includes a correction for cross talk between neighboring portions of the display screen.

8. The method of claim 1, further including the step of activating the light sources of the backlight unit in accordance with the increased light outputs.

9. A display device including a lighting unit having at least first and second light sources each corresponding to a portion of a display screen, further including a controller arranged for:
receiving video image data;
determining a desired light output for each of the first and second light sources, in accordance with the video image data for the corresponding portion of the display screen;
determining a power factor by comparing said desired light outputs to a predetermined reference light output, and
increasing at least one of said desired light outputs by at least a fraction of said power factor.

10. The display device of claim 9, wherein the light sources are fluorescent lamps each corresponding to a segment of the display screen.

11. The display device of claim 9, wherein the light sources are light emitting diodes each corresponding to an area of the display screen.

12. The display device of claim 9, wherein said controller is a timing controller (TCON) connected to row drivers and column drivers of the display screen.
